(19) United States
(12) Patent Application Publication
(10) Pub. No.: US 2009/0307554 A1
(43) Pub. Date: Dec. 10, 2009

(54) METHOD AND APPARATUS FOR PERFORMING A BUNDLED TRANSMISSION

(75) Inventors: Paul Marinier, Brossard (CA); Christopher R. Cave, Montreal (CA); Diana Pani, Montreal (CA); Benoit Pelletier, Roxboro (CA); Vincent Roy, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/429,459

(22) Filed: Apr. 24, 2009

Related U.S. Application Data
(60) Provisional application No. 61/048,094, filed on Apr. 25, 2008.
(60) Provisional application No. 61/048,083, filed on Apr. 25, 2008.
(60) Provisional application No. 61/047,808, filed on Apr. 25, 2008.

(51) Int. Cl. H04L 1/18; G06F 11/14

(52) U.S. Cl. 714/748; 714/E11.113

(57) ABSTRACT

A wireless transmit/receive unit (WTRU) may send a bundled transmission of a packet repeatedly over at least two consecutive transmission time intervals (TTIs). The WTRU may not process a hybrid automatic repeat request (HARQ) feedback for the packet after sending the bundled transmission. The bundled transmission may be configured per HARQ process. The WTRU may override the bundled transmission and may transmit a HARQ retransmission of another packet in one of the TTIs scheduled for the bundled transmission if a TTI scheduled for the HARQ retransmission of another packet overlaps the TTIs scheduled for the bundled transmission. Alternatively, the WTRU may transmit a non-bundled transmission of a packet and send a bundled HARQ transmission of the packet on a condition that HARQ feedback indicates a failure of delivery of the packet. The WTRU may not process an HARQ feedback in an E-HICH for the packet after sending the bundled transmission.

### CROSS REFERENCE TO RELATED APPLICATIONS

This application claims the benefit of U.S. provisional application Nos. 61/048,094 filed Apr. 25, 2008, 61/048,083 filed Apr. 25, 2008, and 61/047,808 filed Apr. 25, 2008, which are incorporated by reference as if fully set forth.

### FIELD OF INVENTION

This application is related to wireless communications.

### BACKGROUND

Enhanced uplink (EU), or high speed uplink packet access (HSUPA), is a feature that was introduced as part of the third generation partnership project (3GPP) Release 6 to provide higher data rates in the uplink of universal mobile telecommunication systems (UMTS) wireless systems. Higher data rates are achieved through the introduction of a new uplink transport channel, an enhanced dedicated channel (E-DCH), which replaces the conventional dedicated channel (DCH) to send user data in the uplink. Key concepts used with E-DCH in order to attain up to 11 Mpbs peak data rate include use of more channelization codes in the uplink, fast Node B scheduling with layer 1 (L1) control, hybrid automatic repeat request (HARQ) and fast L1 retransmissions, support for both 2 ms and 10 ms transmission time interval (TTI) for uplink transmissions, and higher order modulation (16 quadrature amplitude modulation (16QAM) as of 3GPP Release 7).

The use of 2 ms TTI for uplink transmission allows for much faster scheduling of wireless transmit/receive unit (WTRU) transmissions as well as lower overall HARQ transmission latency. The 2 ms TTI, on the other hand, is unfavorable from a coverage standpoint as less energy per bit can be transmitted in power limited situations when compared to the 10 ms TTI. When a WTRU that is using the 2 ms TTI gets out of the coverage area for the 2 ms TTI, the WTRU has to perform a reconfiguration to the 10 ms TTI in order to maintain its connection. Dynamically switching from 2 ms TTI to 10 ms TTI as a WTRU approaches the cell edge is undesirable because it may result in loss of data at a medium access control (MAC) layer.

Autonomous retransmission technique, also known as TTI bundling, has been proposed to improve the coverage area for uplink data transmissions without having to reconfigure from 2 ms TTI to 10 ms TTI. The autonomous retransmission technique allows the WTRU to retransmit a transport block in consecutive TTIs (or TTIs close in time) without waiting for positive acknowledgement (ACK) or negative acknowledgement (NACK) from a Node B. Upon reception of a NACK, the WTRU retransmits the same data burst, (i.e., consecutive retransmissions of the transport block), until an ACK is received. This allows the WTRU to increase the number of re-transmissions, thus the energy per information bit, without increasing as much the overall transmission delay. From energy per bit standpoint, TTI bundling is comparable to having transmitted using a larger TTI value, increasing the uplink coverage.

WTRUs operating with 2 ms TTI may suffer from power limitation at cell edge. This may be particularly problematic for real-time services that have stringent low latency requirements such as voice over IP (VoIP). For E-DCH to be a viable alternative to the DCH, it is desirable to increase the uplink coverage when operating with 2 ms TTI. The autonomous retransmission technique may provide improvements. However, there are currently no existing mechanisms to achieve autonomous retransmissions in wideband code division multiple access (WCDMA). In addition, the uplink data transmission mechanism provided by the E-DCH transport channel also requires the use of downlink control channels, (i.e., E-DCH absolute grant channel (E-AGCH), E-DCH relative grant channel (E-RGCH), and E-DCH HARQ indicator channel (E-HICH). Thus, it is also necessary to improve the downlink performance for these channels. Otherwise, any gain brought by the uplink link budget improvement by autonomous retransmissions may be offset by a loss in downlink coverage.

### SUMMARY

A method and an apparatus for performing a bundled transmission are disclosed. The WTRU may send a bundled transmission of a packet such that the packet is repeatedly transmitted over at least two consecutive TTIs. The WTRU may not process a HARQ feedback in an enhanced HARQ indicator channel (E-HICH) for the packet after sending the bundled transmission. The WTRU may flush a HARQ buffer at completion of the bundled transmission. The WTRU may not process the HARQ feedback in an E-HICH on a condition that an indication via at least one of a high speed shared control channel (HS-SCCH) order, a reserved bit on an E-DCH absolute grant channel (E-AGCH), layer 2 signaling, and layer 3 signaling is received. The WTRU may not process the HARQ feedback in an E-HICH on a condition that the WTRU is in a power limited situation.

The bundled transmission may be configured per HARQ process. The WTRU may override the bundled transmission and may transmit a HARQ retransmission of another packet in one of the TTIs scheduled for the bundled transmission on a condition that a TTI scheduled for the HARQ retransmission of another packet overlaps one of the TTIs scheduled for the bundled transmission. In this case, a total number of autonomous transmissions of the packet in the bundled transmission is calculated as a number of TTIs of the bundled transmission minus a number of TTIs for the HARQ retransmission of another packet.

Alternatively, the WTRU may transmit a non-bundled transmission of a packet and send a bundled HARQ transmission of the packet on a condition that HARQ feedback indicates a failure of delivery of the packet. The WTRU may not process an HARQ feedback in an E-HICH for the packet after sending the bundled transmission. The WTRU may flush an HARQ buffer at completion of the bundled transmission.

### BRIEF DESCRIPTION OF THE DRAWINGS

A more detailed understanding may be had from the following description, given by way of example in conjunction with the accompanying drawings wherein:

FIG. 1 shows example bundled retransmissions in accordance with one embodiment;

FIGS. 2 and 3 show example bundled retransmissions at the second and subsequent HARQ transmissions in accordance with other embodiments;

FIG. 4 shows example bundled retransmissions configured per-HARQ process basis;

FIGS. 5A and 5B show an example arrangement with two patterns of bundled transmissions in accordance with another embodiment;

FIG. 6 shows transmission of downlink control information in accordance with another embodiment;

FIG. 7 shows autonomous retransmission of a TTI bundle in the cycle of eight (8) TTIs without HARQ feedback or HARQ retransmissions in accordance with another embodiment;

FIG. 8 is an example WTRU;

FIG. 9 shows conventional HARQ transmission and retransmissions;

FIG. 10 shows collision between a normal HARQ retransmission and a bundled transmission;

FIG. 11 shows a bundled transmission given a priority over a normal HARQ retransmission; and

FIG. 12 shows a normal HARQ retransmission given a priority over a bundled transmission.

### DETAILED DESCRIPTION

When referred to hereafter, the terminology “WTRU” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “Node B” includes but is not limited to a base station, a site controller, an access point (AP), or any other type of interfacing device capable of operating in a wireless environment.

When referred to hereafter, the terminologies “TTI bundling”, “bundled transmission”, and “autonomous retransmissions” will be used interchangeably.

Embodiments for autonomous bundled retransmissions to extend the uplink coverage are disclosed hereafter.

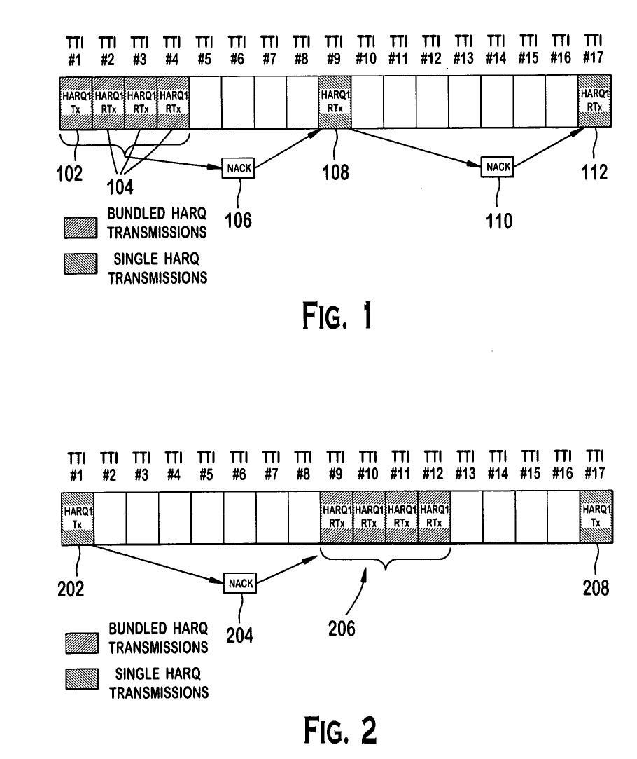

In accordance with one embodiment, a WTRU may send a bundled transmission, (i.e., initial transmission followed by autonomous retransmission(s)), only for the first HARQ transmission, (i.e., prior to reception of any ACK or NACK feedback for the HARQ process). Optionally, the WTRU may be configured to send non-bundled HARQ retransmissions following reception of a NACK or DTX on the associated E-HICH. FIG. 1 shows an example bundled transmission in accordance with this embodiment. A WTRU sends an initial HARQ transmission 102 at TTI #1 followed by consecutive HARQ retransmissions 104 at TTI #2 through TTI #4, (i.e., bundled transmission through TTI #1 through TTI #4). The HARQ retransmissions 104 in the bundled transmission are transmitted without waiting for an acknowledgement from a Node B. Upon reception of a NACK 106, 110 from the Node B, the WTRU may send a single non-bundled HARQ retransmission 108, 112, respectively.

In accordance with this embodiment, the WTRU sends the bundled transmission for the first HARQ transmission only. Since HARQ retransmissions 104 benefit from additional temporal diversity, the bundled transmission might not be required on subsequent HARQ retransmissions. Reducing the number of retransmissions is advantageous in terms of uplink noise rise and WTRU battery consumption. This scheme may be advantageous for delay sensitive applications, such as VoIP. Although the bundled transmission is shown in consecutive TTIs (TTI #1 through TTI #4) in FIG. 1, the retransmissions in the bundled transmission may be separated by one or several TTIs.

In accordance with this embodiment, the Node B may reduce its downlink channel overhead load by not transmitting an E-HICH for WTRUs at cell edge or for WTRUs that are performing E-DCH autonomous retransmissions or TTI bundling, effectively applying E-HICH discontinuous transmission (DTX). By doing so, the total power available for transmitting downlink data is increased. This approach may be applied, but is not limited, to a WTRU with real-time services such as VoIP where a transmission may no longer be relevant after a short number of retransmissions due to excessive delays and where guarantee of delivery is not mandatory. Since WTRUs at cell edge are power-limited, it is likely that a maximum number of retransmissions configured or predefined for bundled operations may be used and the E-HICH may be redundant.

To maintain efficient transmission power utilization, a WTRU at cell edge may be configured to automatically retransmit a PDU for a given TTI, or a TTI bundle, for a certain number (N) of retransmissions without HARQ feedback. N may be zero (0) or any integer number greater than zero (0). As opposed to autonomous retransmissions within a TTI bundle, the TTI or TTI bundle retransmissions may occur every HARQ cycle and may therefore take full advantage of variations in channel conditions. FIG. 7 shows autonomous retransmission of a TTI bundle in the cycle of eight (8) TTIs without HARQ feedback or HARQ retransmissions. A WTRU transmits a bundled transmission 702 comprising an initial transmission 704 followed by three autonomous retransmissions 706, (i.e., TTI bundle). The WTRU may simply consider that the delivery of this bundled transmission would be successful and may not expect or receive or decode HARQ feedback for this bundled transmission, and may transmit another TTI bundle 708, 710 at the next cycle, (e.g., every 8 TTIs), where the data in the TTI bundle 708 corresponds a new MAC PDU in the case if N=0. At the end of the bundle transmission, the WTRU may flush the corresponding HARQ buffer and for the next HARQ cycle 708, the WTRU may determine that the HARQ buffer is empty and may perform E-TFC selection for the next TTI for a new transmission. Alternatively, the subsequent TTI bundle(s), (e.g., the TTI bundle 708), may be a repetition of the previous bundle 702 if N>0, (i.e., the WTRU may transmit a bundle for a configured or a determined consecutive number of TTIs).

Under the conventional 3GPP specifications, if a WTRU does not receive an E-HICH, the WTRU will retransmit the HARQ transmission. Therefore, the WTRU needs to be aware that the Node B is not transmitting ACK/NACK or the WTRU needs to be aware not to take into account the ACK/NACK feedback and the network needs to quickly detect cell edge conditions or the triggers to stop ACK/NACK feedback. The following embodiments may be used to address these issues. This embodiment, as opposed to letting the UTRAN perform DTX without configuring the WTRU, has an advantage of not being exposed to DTX-to-ACK errors, which reduce the effective channel throughput.

In accordance with one embodiment, a WTRU may be informed explicitly or implicitly that a Node B stops transmitting E-HICH (i.e., E-HICH DTX activation). The WTRU may be informed explicitly or implicitly by using one or combination of the following mechanisms:

(1) an HS-SCCH order—the HS-SCCH order may also correspond to the order that activates or deactivates TTI bundling (if applicable);

(2) a special, reserved bit or combination of bits on the E-AGCH;

(3) L2 signaling. The control information may be appended to the MAC-ehs or MAC-hs PDU. The presence may be indicated in the MAC-ehs header using a reserved value of the LCH-ID. Additionally, the four (4) remaining bits in the header following the logical channel identity (LCH-ID) may be used to indicate what information is appended to the payload;

(4) L3 signaling. An RRC message may be used to configure the WTRU with E-HICH or lack of E-HICH information. The network may provide to the WTRU an activation time at which the given configuration shall take place;

(5) The WTRU may use the triggers associated to the initiation of TTI bundling, (i.e., E-DCH bundled transmission), to determine whether the E-HICH is transmitted or whether the E-HICH information should be passed to the HARQ entity and be taken into account. If the WTRU is performing autonomous retransmissions or TTI bundling, the WTRU may not expect (monitor or process) the E-HICH, and if normal single transmission is ongoing the WTRU may perform normal HARQ operation and expect (monitor and process) E-HICH feedback;

(6) If the WTRU DTX and TTI bundling are ongoing, the WTRU may not expect (monitor or process) the E-HICH; and

(7) If the TTI bundle size is above a threshold the WTRU may not expect (monitor or process) E-HICH feedback, otherwise the WTRU expects, monitors and processes feedback.

The network may decide or be configured to only transmit E-HICH for a subset of HARQ processes. In one embodiment, a Node B may apply E-HICH DTX for all the HARQ processes carrying non-scheduled transmissions, or for all HARQ processes carrying only non-scheduled transmissions. Alternatively, the network may configure E-HICH DTX per-HARQ processes, for example, upon configuration of the radio link via RRC signaling or for all HARQ processes in which TTI bundling is being performed.

Once the indication has been detected by the WTRU, the WTRU may stop monitoring or processing the E-HICH in TTIs known to be in E-HICH DTX, or automatically retransmit (up to a configured maximum number of attempts) the HARQ processes configured for E-HICH DTX.

Similar mechanisms may be used to de-activate the E-HICH DTX mode.

Alternatively, the E-HICH DTX may be linked with the number of E-DCH autonomous retransmissions from the WTRU. For instance, a WTRU may be configured to expect E-HICH feedback if the number of E-DCH autonomous retransmissions or total number of bundle transmissions is 2 or 4 or less than a configured number. For example, if the WTRU is configured with eight (8) E-DCH autonomous retransmissions, the WTRU may implicitly know not to monitor the E-HICH channel of all Node Bs in its E-DCH active set and the Node Bs do not send E-HICH feedback. The link between the number of E-DCH autonomous retransmissions and E-HICH feedback may be pre-defined, preconfigured in the WTRU, or configured by higher layer signaling when the TTI bundling is configured and/or activated.

In accordance with another embodiment, a WTRU may inform the network of cell edge conditions. A report may be triggered at the WTRU to indicate cell edge conditions to the network. For example, the report may be triggered in any one of the following conditions:

(1) if a WTRU power headroom (UPH) falls below a given threshold

(T_{uph,in}), triggering either a measurement report or transmission of scheduling information (SI);

(2) if the serving cell path loss is above a given threshold (T_{pl,in}), triggering a measurement report with an existing or new cause, (e.g., cell edge condition); or

(3) if the serving cell common pilot channel (CPICH) Ec/No or received signal code power (RSCP) is below a given threshold (T_{cpich,in}), triggering a measurement report with an existing or new cause (e.g.: cell-edge condition). The thresholds may be pre-defined or configured by the network.

Optionally, upon transmission of the measurement report or SI, the WTRU may be configured to automatically assume that the E-HICH DTX mode is activated at the Node B (potentially after a pre-defined or configured activation time). Alternatively, the WTRU may have to wait for an acknowledgement from the network that the message has been received or for an explicit indication from the Node B.

Similarly, to deactivate the E-HICH DTX mode, the WTRU may be configured with a different set of thresholds to indicate the end of cell edge conditions. The conditions for deactivating E-HICH DTX may be linked to the conditions of triggering the deactivation of TTI bundling. For example, one or more of the following conditions may be used to trigger the report:

(1) The UPH is above a given threshold (T_{uph,out}), triggering either a measurement report or transmission of the SI;

(2) The serving cell path loss is below a given threshold (T_{pl,out}), triggering a measurement report with an existing or new cause, (e.g., cell edge condition); or

(3) The serving-cell CPICH Ec/No or RSCP is above a given threshold

(T_{cpich,out}), triggering a measurement report with an existing or new cause, (e.g., cell edge condition). The thresholds may be pre-defined or configured by the network.

Optionally, upon transmission of the measurement report or SI, the WTRU may be configured to automatically assume that the E-HICH DTX mode is de-activated at the Node B (potentially after a given pre-defined or configured activation time). At which point the WTRU may resume monitoring the E-HICH and act accordingly.

It should be noted that although the various embodiments are described separately, the disclosed embodiments may be used in any combination as well.

In accordance with another embodiment, a WTRU may send a bundled transmission after the WTRU receives a NACK from the Node B for a given HARQ process. FIG. 2 shows an example bundled transmission at the second HARQ transmission, (i.e., the bundled transmission is the first HARQ retransmission after receiving a NACK), in accordance with this embodiment. A WTRU sends an initial HARQ transmission 202 at TTI #1. The initial HARQ transmission 202 is a single non-bundled HARQ transmission. After receiving a NACK 204 for the initial HARQ transmission, the WTRU sends a bundled HARQ transmission 206 at TTI #9 through TTI #12. Once a bundled transmission is performed, the WTRU may behave according to one of the embodiments described herein. In one option, the WTRU does not perform any additional retransmissions, (i.e., does not expect any ACK/NACK feedback), and starts a new transmission at the next TTI 208 for the HARQ process. Optionally, after the bundled HARQ transmission is negatively acknowledged, the WTRU may send a signal non-bundled HARQ retransmission.

Alternatively, the bundled transmission may be sent on subsequent HARQ transmissions of a given HARQ process as well, as shown in FIG. 3. In FIG. 3, the WTRU sends an initial HARQ transmission 302 at TTI #1. The initial HARQ transmission 302 is a single non-bundled HARQ transmission. After receiving a NACK 304 for the initial HARQ transmission, the WTRU sends a bundled HARQ transmission 306 at TTI #9 through TTI #12. The WTRU sends another bundled HARQ transmission 310 after receiving a NACK 308. The WTRU may continue bundled transmissions until reception of an ACK or until the completion of the HARQ process, (i.e., exhaustion of the maximum number of HARQ transmissions).

FIG. 3 also shows coordination of the activation of bundled transmissions when some TTIs are already busy due to retransmissions from other HARQ processes. As shown in FIG. 3, the WTRU is unable to start the bundled transmission on the first transmission of HARQ process #1 as TTI #2 and TTI #3 are busy with retransmissions from other HARQ processes. The WTRU waits until the TTIs following a transmission on HARQ process #1 become available to start the bundled transmission, as can be from TTI #9 through TTI #12. The WTRU may then start bundled transmission for all HARQ process #1 transmissions from that point forward (or until the bundled transmission is deactivated).

Although the bundled transmission is shown in consecutive TTIs in FIG. 3, the retransmissions in the bundled transmission may be separated by one or several TTIs.

When TTI bundling is activated, the WTRU may have data being transmitted on the active HARQ processes that will be deactivated due to the TTI bundling activation. In this case, the WTRU may flush all active HARQ processes that will be disabled due to TTI bundling. Alternatively, the WTRU may attempt to successfully transmit the data on the active HARQ processes prior to initiating TTI bundling. The WTRU may take the data from those HARQ processes and retransmit them over the active HARQ processes once TTI bundling is enabled or flush the HARQ processes and optionally report the discarded PDU(s) to a radio link control (RLC) layer if acknowledge mode (AM) data is being transmitted or to the MAC-i/is layer in case the PDU had been segmented. In this case, the MAC-i/is layer may discard the remaining segment(s) corresponding to the discarded PDU, and the RLC layer may retransmit the RLC PDU that was discarded in the given HARQ process.

Alternatively, in order to avoid loss of data, the WTRU may be configured to start TTI bundling at a fixed number (X) of HARQ round trip times (RTTs) after the reception of the activation/deactivation signal. In this case, the WTRU has up to X transmissions to successfully send the data in the HARQ processes that are to be disabled. During this time, the WTRU may be restricted from transmitting new data over these HARQ processes. The WTRU may transmit new data over the HARQ processes that will be used during TTI bundling.

In yet another alternative, if an activation time is specified, the WTRU may attempt to transmit all data in the HARQ processes to be deactivated, prior to the expiration of the activation time (e.g., N HARQ RTT in advance).

The WTRU behavior is described when short-lived TTI bundling is used. When short-lived TTI bundling is used, the WTRU uses TTI bundling along with normal HARQ operations. While the WTRU may use HARQ retransmissions for the TTI bundle, to simplify the description it will be assumed that only one TTI bundle transmission is carried out. Many of the mechanisms described herein may be applied to HARQ retransmissions of a TTI bundle.

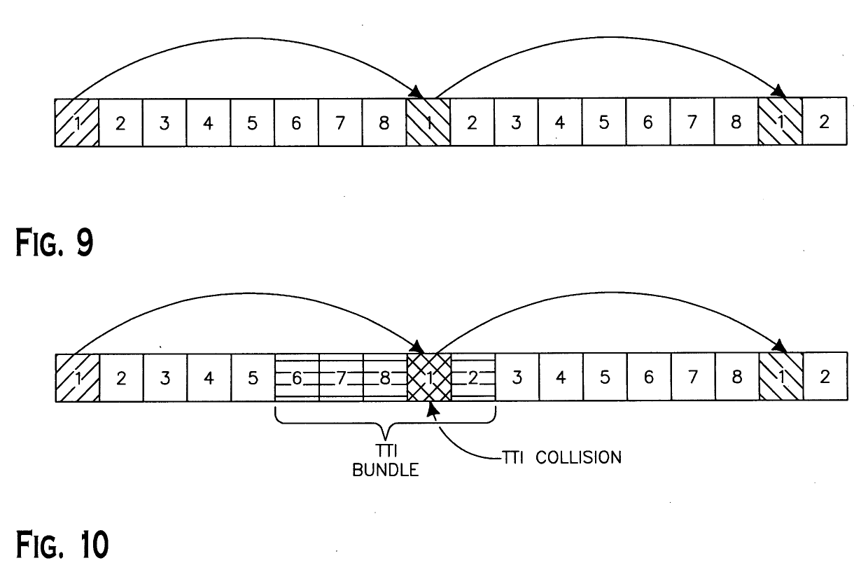

Normal synchronous HARQ operation (used for example in the E-DCH of wideband code division multiple access (WCDMA) frequency division duplex (FDD)) with a first transmission and two HARQ retransmissions is illustrated in FIG. 9 for a 2 ms TTI. In synchronous operations, the HARQ processes are directly linked to the time, (e.g., CFN, subframe index, etc.). Therefore, there is no ambiguity as to which HARQ process is concerned upon HARQ retransmission, and there is no need to explicitly signal the HARQ process identity, saving uplink bandwidth.

One drawback of synchronous HARQ when operating in conjunction with TTI bundling is the possibility of collisions between a normal HARQ retransmission and an autonomous retransmission as part of a TTI bundle. This is illustrated in FIG. 10, where a normal HARQ process (process #1) is shown with two retransmissions, along with a TTI bundle of 5 TTIs starting at HARQ process #6. As shown in FIG. 10, the first HARQ retransmission of HARQ process #1 will collide with the autonomous retransmissions of the TTI bundle starting in HARQ process #6.

To resolve this potential collision, the following priority-based example mechanisms are disclosed and a WTRU may be configured to implement the same.

In accordance with one embodiment, the WTRU may verify if the upcoming HARQ processes will be occupied (e.g., with HARQ retransmission) before starting the TTI bundle. A HARQ process may be considered occupied when one or more of the following are detected: (1) the HARQ process buffer is not empty; (2) the WTRU has not reached the maximum number of HARQ retransmissions; (3) the data in the HARQ process buffer has higher priority than the data to be transmitted (i.e., the data in the transmit buffer); or (4) a transmission, or retransmission, for that HARQ process occurred during the previous frame, but the response on the E-HICH has not yet been detected by the WTRU due to the timing of the E-HICH and WTRU processing time.

The WTRU may then determine the largest TTI bundle size that may be used based on a maximum TTI bundle size, pre-defined or configured by the network, and the occupancy of the upcoming HARQ processes. The largest TTI bundle size is calculated by subtracting the time index associated with the next occupied HARQ process and the time index of the current TTI (or the TTI for which bundling is considered). This largest TTI bundle size may be used for E-TFC restriction and E-TFC selection. By restricting the TTI bundle size in such a way, TTI collisions may be avoided.

The network, such as UTRAN, may also configure a minimum TTI bundle size. As such, if the largest TTI bundle size is smaller than the minimum TTI bundle size configured by the network, the WTRU may be configured to perform one or more procedures. For example, the WTRU may be configured to not transmit using TTI bundling (and use regular HARQ transmissions and retransmissions operations).

Alternatively, the WTRU may also hold E-TFC selection and postpone new data transmission until a TTI bundle equal to or larger than the minimum bundle size can be used. In this alternative procedure, the WTRU maximum delay may be configured by the network after which time the WTRU may no longer wait for TTI bundling. The WTRU maximum delay may be configured by the network for each MAC-d flow. When the WTRU multiplexes multiple MAC-d flows, the WTRU uses the smallest delay of all the maximum delays configured for the multiplexed MAC-d flows. The WTRU maximum delay may be implicit based on the priority of each MAC-d flow or on the priority of each logical channel.

The WTRU may also use a normal HARQ transmission on the current HARQ process for the first transmission. If for the next transmission on this HARQ process the WTRU has to perform a retransmission, the WTRU re-evaluates the above mentioned condition to determine whether it may send the retransmission using TTI bundling. If the conditions are met (i.e., the largest TTI bundle size is not smaller than the minimum TTI bundle size), the WTRU may perform TTI bundling on this HARQ process.

When there are no TTI collision avoidance mechanisms, the WTRU may transmit either the TTI bundle autonomous retransmission or the colliding HARQ retransmission.

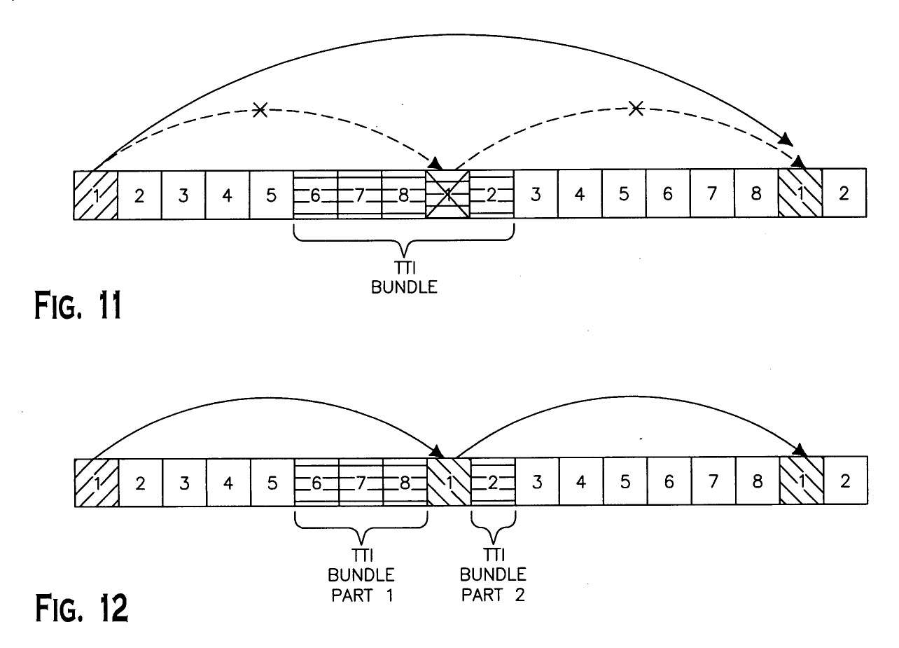

When transmission priority to TTI bundle autonomous retransmission is used, the transmission priority may always be given to the TTI bundle autonomous retransmission. This is illustrated in FIG. 11. The first HARQ retransmission of HARQ process #1 does not take place. Instead, the autonomous retransmission for the TTI bundle starting at HARQ process #6 takes priority. When such overriding of the HARQ retransmission occurs, the data in the overridden HARQ process has a larger probability of not being received correctly. If a large number of HARQ retransmissions is configured for the MAC-d flow being transmitted, the impact may be small. However, for delay-sensitive applications, such as voice and perhaps for signaling radio bearers (SRBs), the added delay and potential increase rate of failure may be significant.

To control the impact of overriding a HARQ retransmission, the WTRU may, for example, increment the current number of HARQ transmissions for the overridden HARQ process (and act appropriately if the maximum number of transmission is reached), without retransmitting the data in this HARQ process. Alternatively, the current number of HARQ transmission for the overridden HARQ process is not incremented. Alternatively, the decision to increment the current number of HARQ transmissions for the overridden HARQ process may be based on at least one of the multiplexed PDU in the HARQ buffer being associated to a non-scheduled flow; the highest priority of the data in the HARQ buffer being above a configured threshold; the lowest priority of the data in the HARQ buffer being above a configured threshold; at least one of the multiplexed PDU in the HARQ buffer being associated to a MAC-d flow configured by the network for always incrementing in this case; or at least one of the multiplex PDU in the HARQ buffer being associated to a MAC-d flow configured by the network for not incrementing in this case.

The WTRU may also terminate the overridden HARQ process (i.e., assume that an ACK was received or that the maximum number of transmissions has been reached, and flush the corresponding HARQ buffer). Increasing the transmission power for the remaining HARQ retransmissions by some calculated or preconfigured amount by the WTRU may also be used to control the impact of overriding a HARQ retransmission.

The network may configure each MAC-d flow separately to indicate whether or not for this MAC-d flow the number of retransmissions should be incremented or not. This may be achieved, for example, by adding an entry in the E-DCH MAC-d flow configuration IE.

Further, when overriding of a HARQ retransmission occurs, the WTRU should not consider the associated ACK/NACK feedback for that HARQ process. Depending on the implementation or scenario, this ACK/NACK may be sent in response to the overriding TTI bundle.

Alternatively, the transmission priority may always be given to the HARQ retransmissions. This method is illustrated in FIG. 12, where it is shown that the TTI bundle is split into two parts, and one of the TTI bundle autonomous retransmissions is replaced by the first HARQ retransmission of HARQ process #1, which has higher priority. When such overriding of a TTI bundle autonomous retransmission occurs, the WTRU may increase the power offset of the TTI bundle E-DPDCH by a factor calculated based on the effective TTI bundle size. Alternatively, the power offset of the TTI bundle autonomous retransmissions occurring after the colliding TTI is increased by a calculated factor. The WTRU may also increase the power offset of the TTI bundle E-DPCCH by a factor calculated based on the effective TTI bundle size.

Alternatively, the transmission priority may be determined by the content in the HARQ buffers. For example, if the data in the HARQ buffer associated to the TTI bundle has higher priority than the data in the colliding HARQ retransmission, the TTI bundle has priority over the HARQ retransmission. If the data in the HARQ buffer associated with the TTI bundle has lower priority than the data in the colliding HARQ retransmission, the HARQ retransmission has priority over the HARQ retransmission. In case of equal priority in the data buffers, then a default behavior may be pre-defined and one of the disclosed methods herein may be used.

The transmission priority between a bundled retransmission and a normal HARQ (re-)transmission for a HARQ process scheduled for a certain TTI may alternate between successive HARQ cycles of TTIs, (e.g., 8 TTIs). This means that if transmission for a certain HARQ process has been overridden by a bundled retransmission at a certain TTI, transmission from this HARQ process will have higher priority than the bundled retransmission the next time this HARQ process is scheduled (i.e., one HARQ cycle, or 16 ms, later). The alternating pattern of priorities may be fixed or a function of, for example, the SFN, or depend on the first time when a bundled transmission is sent.

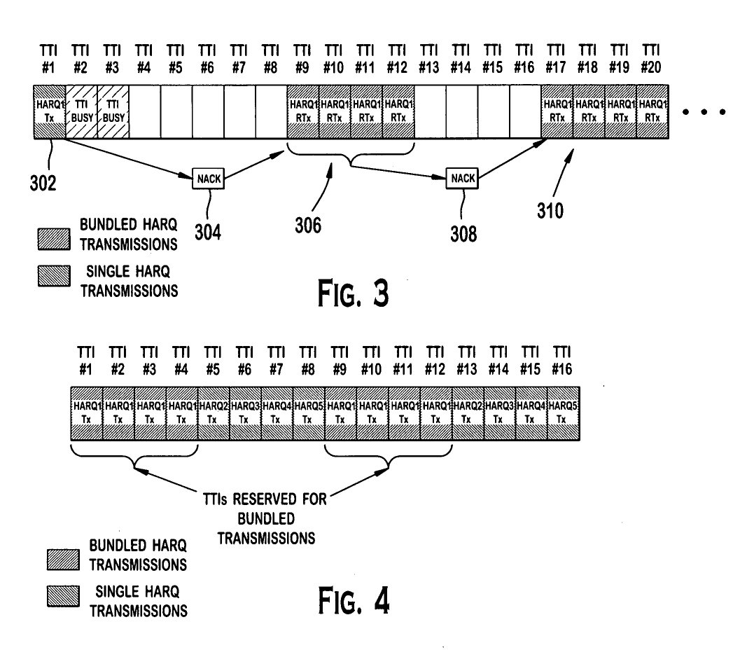

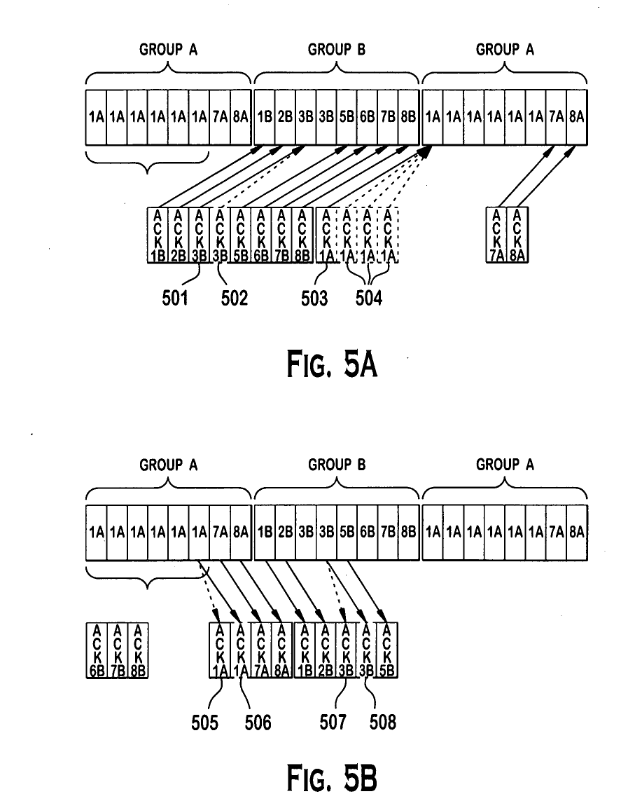

In accordance with another embodiment, the bundled transmission, (i.e., autonomous retransmissions), may be configured per-HARQ process for a given WTRU rather than performing bundled transmission for all active HARQ processes. FIG. 4 shows example bundled transmission configured per-HARQ process basis. In FIG. 4, a WTRU is configured such that a bundled transmission is performed on HARQ process #1 whereas single HARQ transmissions are performed on HARQ processes #2 through #5. The bundled transmission for the HARQ process #1 is transmitted via TTIs #1 through #4 and TTIs #8 through #12 and so on and single HARQ transmissions for HARQ process #2 through #5 are transmitted via TTIs #5 through 8 and TTIs #13-16, and so on.

The number of transmissions in a bundled transmission, for example ranging from 1 to 8, may be configured per HARQ process upon radio bearer establishment or reconfiguration. Alternatively, the number of transmissions in a bundled transmission per HARQ process may be pre-configured, (i.e., the WTRU always uses the same setting).

Optionally, a method for HARQ process selection for uplink transmission may be defined at the WTRU. For example, a set of allowed HARQ processes may be maintained at the WTRU and dynamically updated based on radio conditions, (e.g., on a TTI-basis or over any other short-term time interval). If a HARQ process is configured with fewer number of transmissions in a bundled transmission than it would be required to send out data, (e.g., a WTRU is power limited and is thus does not have sufficient power to reliably send out the transport block (TB) in a single TTI), the HARQ process may be removed from the set of allowed HARQ processes. Moreover, HARQ process selection and E-DCH transport format combination (E-TFC) selection may be performed according to a joint optimization criterion. For example, one joint optimization approach may be designed to select an HARQ process at every new E-DCH transmission opportunity such as to avoid MAC segmentation as much as possible for a given radio link control (RLC) protocol data unit (PDU).

In accordance with another embodiment, a WTRU may perform asynchronous HARQ retransmissions instead of synchronous retransmissions. Asynchronous HARQ allows more flexibility in activating and deactivating bundled transmissions and avoids the loss of data. In order to allow for asynchronous HARQ, a WTRU may indicate a HARQ process number to a Node B as part of the control information that is sent in the E-DPCCH.

In accordance with another embodiment, HARQ cycles of N TTIs, (e.g., N 8), alternate between two or more cycles containing different patterns of bundled transmissions. This arrangement allows the transmission of data requiring bundled transmissions as well as transmission of data not requiring bundled transmissions or requiring fewer transmissions in a bundled transmission when the number of transmissions in a bundled transmission is large for one type of data. FIGS. 5A and 5B show an example arrangement with two patterns of bundled transmissions in accordance with this embodiment. In the example of FIGS. 5A and 5B, TTIs are grouped into alternating two groups A and B of eight (8) TTIs. Among the configured HARQ processes, HARQ processes 1A and 3B involve bundled transmissions (five (5) retransmissions in a bundled transmission for HARQ process 1A and one (1) retransmission in a bundled transmission for HARQ process 3B). HARQ processes 1A, 7A and 8A are transmitted in TTI group A and HARQ processes 1B, 2B, 3B, 5B, 6B, 7B and 8B are transmitted in TTI group B.

With this configuration there are two options for the timing of the HARQ acknowledgments. In accordance with option 1, the HARQ acknowledgment 501, 503 pertaining to a particular HARQ process is transmitted M TTIs before the next transmission on this HARQ process, (e.g., M=5 in FIG. 5A). HARQ acknowledgment may be repeated a number of times if the following TTIs are not needed to acknowledge another HARQ process and if these TTIs occur before the start of the next transmission on this HARQ process, (e.g., ACK 3B 502 and ACK 1A 504).

In accordance with option 2, the HARQ acknowledgment 505, 507 pertaining to a particular HARQ process is transmitted L TTIs after the last bundled transmission for this HARQ process, (e.g., L=3 in FIG. 5B). As in Option 1, the HARQ acknowledgment may be repeated if the corresponding TTIs are not needed to acknowledge another HARQ process, (e.g., ACK 1A 506 and ACK 3B 508).

The HARQ transmission or transmissions on which bundled transmissions may be performed may be configured by a higher layer upon radio bearer configuration or reconfiguration. Alternatively, a WTRU may be pre-configured to perform bundled transmissions on certain HARQ transmissions, (e.g., the WTRU may always use the same setting).

The network may configure the WTRU via layer 1, 2, or 3 signaling or in any combination thereof. The network may use the E-AGCH to convey configuration parameters for bundled transmissions. The configuration parameters may be signaled using a new E-AGCH structure defined for this purpose or changing the function or interpretation of a certain field in the conventional E-AGCH. Alternatively, a new L1 channel may be defined to convey the configuration parameters for bundled transmissions. Alternatively, a high speed shared control channel (HS-SCCH) order may be used to provide the WTRU with the indication that the subsequent transmission or retransmission may or may not use bundled transmissions.

Alternatively, new L2 signaling may be used to configure the WTRU as to the sequence of transmission and retransmission where bundled transmissions may be used. For example, a new header field may be included in a MAC-ehs or MAC-hs header to convey this configuration information. Alternatively, a special value of the logical channel ID may be used to indicate to the WTRU that this configuration information follows at the end of the payload.

The network may configure the WTRU with the sequence of transmission and retransmissions where bundled transmissions may be used using radio resource control (RRC) signaling. This may be achieved by adding a new information element (IE) or modifying a conventional IE in RRC control messages, such as radio bearer configuration or reconfiguration message, or transport channel configuration or reconfiguration message. The IE “E-DCH info” used to configure E-DCH operation may be extended to provide this configuration information.

The RRC message may also be used to configure the WTRU with the TTI bundling pattern including, but not limited to, the number of HARQ process ID, the number of retransmissions per HARQ process ID if different on a per HARQ process level or any of the indications described above.

Embodiments for extending the coverage of downlink control channels used to support the transmission of uplink data over E-DCH in evolved HSPA systems are disclosed hereafter.

In accordance with one embodiment, the information from a downlink control channel, (i.e., E-AGCH, E-RGCH and/or E-HICH), pertaining to a given HARQ process is repeated a configured number of times in a series of 2 ms TTIs sent during periods of time known to the WTRU to improve the downlink link budget. The WTRU receives, and combines, the signals containing the control channel information during the configured periods to decode the downlink control information.

The downlink control information may be encoded in exactly the same way for every TTI in which the information is transmitted, and the coded bits may be the same for every TTI. This simplifies the decoder implementation in the WTRU. The encoding may be modified to take advantage of the higher number of symbols provided by the repetition of the information over multiple TTIs. For instance, in case of the E-AGCH, the information bits (including the E-DCH radio network temporary identity (E-RNTI)-masked cyclic redundancy check (CRC)) may be encoded at a lower rate and interleaved over the symbols from all TTIs.

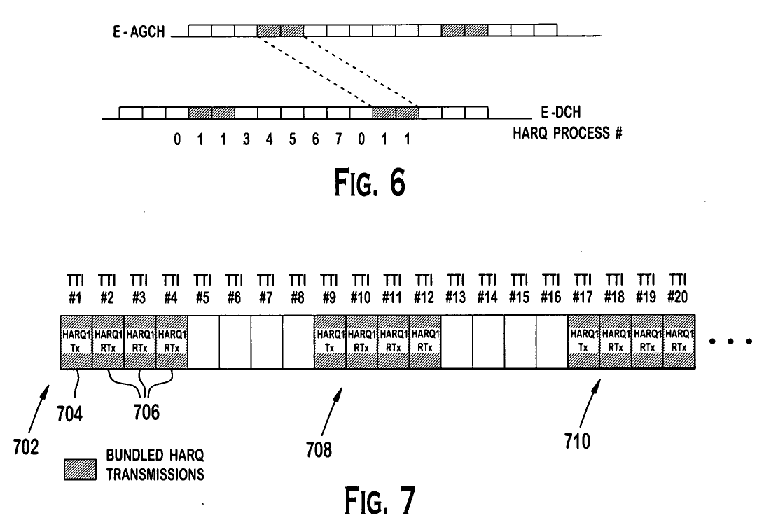

The transmission timing for the information to be transmitted over a controlled channel may have the same timing relationship with the conventional E-DCH. For instance, the absolute grant information pertaining to a given E-DCH transmission may be transmitted approximately five (5) TTIs before the E-DCH transmission. The WTRU determines that the information in two or several TTIs of the control channel, (e.g., the E-AGCH), is the same if the WTRU performs bundled transmissions, (i.e., autonomous retransmissions), in the corresponding TTIs of the E-DCH. FIG. 6 shows transmission of downlink control information in accordance with this embodiment. In FIG. 6, a Node B transmits E-AGCH transmissions in two consecutive TTIs. The information from these TTIs is known to be the same as they pertain to E-DCH TTIs that pertain to the same HARQ process, (e.g., HARQ process #1 in FIG. 6). The WTRU receives the E-AGCH transmissions in two consecutive TTIs and may combine the bits from these two TTIs to improve the probability of successful decoding. A similar technique may also be implemented for the E-RGCH and E-HICH transmissions.

Alternatively, a different timing relationship may be applied between the control channel and the E-DCH transmission than the prior art. The conventional E-HICH transmission starts three (3) TTIs after the initial E-DCH transmission. For example, if the initial E-DCH transmission from the WTRU is followed by three (3) consecutive autonomous retransmissions and a Node B combines all the transmissions before decoding, the Node B may not determine if the packet is successfully decoded or not before the Node B has to send an acknowledgment over the E-HICH if the conventional E-HICH timing relationship is kept because all autonomous retransmissions from the WTRU and decoding and necessary processing at the Node B are not yet completed by the time the E-HICH transmission is required. To resolve this issue, an implicit timing relationship may be established where the initial E-HICH transmission (or other control channel information) pertaining to a bundled transmission is offset by a delay dependent on the number of autonomous retransmissions in the bundled transmission to ensure that the initial E-HICH transmission (or other control channel information) does not have to start before all autonomous retransmissions in the bundled transmission are completed and the Node B has sufficient time to determine if decoding is successful or not or to complete any necessary processing.

The number of E-HICH (or other control channel) transmissions that contain the same information may also depend on the number of E-DCH autonomous retransmissions in the bundled transmission from the WTRU. The total number of E-HICH transmissions may be the same as the total number of autonomous retransmissions (optionally plus the initial transmission) in the bundled transmission on the E-DCH.

In accordance with another embodiment, the information carried on the downlink control channels may not be repeated in multiple TTIs. Instead, the Node B transmitter may use a transmission power that is a function of the number of E-DCH autonomous retransmissions in the bundled transmission for the packet corresponding to the downlink control channel transmission. The transmission power may be proportional, (e.g., in linear units), to the total number of E-DCH autonomous retransmissions (optionally plus the initial transmission) in the bundled transmission. This ensures that the uplink and downlink performance stay balanced.

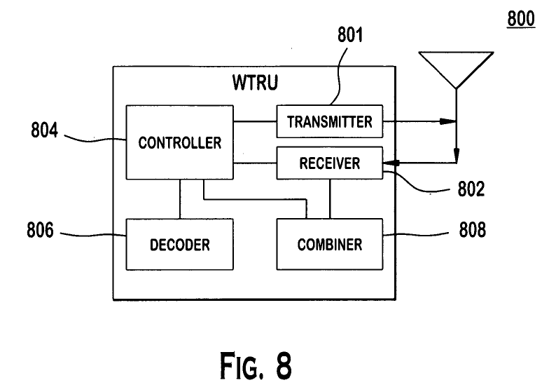

FIG. 8 is an example WTRU 800. The WTRU 800 includes a transmitter 801, a receiver 802, and a controller 804, and a decoder 806. The WTRU 800 may also include a combiner 808. The transmitter 801 is configured to transmit a packet for 2 ms TTI E-DCH transmission. The controller 804 is configured to control the transmitter 801, the receiver 802, the combiner 808, and the decoder 806 to perform the functions disclosed above. For example, the controller 804 may be configured to control the transmitter 801 to send a bundled transmission of a packet such that the packet is repeatedly transmitted over at least two 2 ms TTIs. The controller 804 may not receive HARQ feedback for the packet after sending the bundled transmission.

The controller may be configured to flush a HARQ buffer at completion of the bundled transmission and generate a new packet for an E-DCH transmission for a next HARQ cycle on a condition that data is available. The controller may be configured to not process the HARQ feedback in an E-HICH on a condition that an indication via at least one of an HS-SCCH order, a reserved bit on an E-AGCH, layer 2 signaling, and layer 3 signaling is received. The controller may be configured to not process the HARQ feedback in an E-HICH on a condition that the WTRU is in a power limited situation.

The bundled transmission may be configured per HARQ process. The controller may be configured to transmit HARQ retransmission of another packet in one of the TTIs scheduled for the bundled transmission on a condition that a TTI scheduled for the HARQ retransmission of another packet overlaps one of the TTIs scheduled for the bundled transmission. In this case, the controller may calculate a total number of autonomous transmissions of the packet in the bundled transmission as a number of TTIs of the bundled transmission minus a number of TTIs for the HARQ retransmission of another packet.

The controller may be configured to control the transmitter to send an HARQ transmission of the packet via a non-bundled transmission over one TTI, and send a bundled HARQ transmission of the packet over at least two TTIs on a condition that the HARQ feedback indicates a failure of delivery of the packet. The controller may be configured to not process an HARQ feedback in an E-HICH for the packet after sending the bundled transmission.

The controller 804 may be configured to receive an indication indicating that an E-HICH DTX has been activated, and send the bundled transmission in response to the indication. The controller 804 may be configured to detect a cell edge condition, report the cell edge condition to a network, and send a bundled transmission upon reporting the cell edge condition.

The receiver 802 may be configured to receive a downlink control channel for supporting E-DCH transmissions for at least two 2 ms TTIs. The combiner 808 may be configured to combine soft bits received on the downlink control channel for the at least two TTIs. The decoder 806 may be configured to decode the combined soft bits to obtain downlink control information.

The controller 804 may be configured to control the transmitter 801 to send a bundled initial HARQ transmission of the packet such that the packet is repeatedly transmitted over at least two TTIs without waiting for an acknowledgement for the packet, and receive HARQ feedback for the packet via an E-HICH, and send a non-bundled HARQ retransmission of the packet over one TTI on a condition that the HARQ feedback indicates a failure of delivery of the packet. Alternatively, the controller 804 may be configured to control the transmitter 801 to send an initial non-bundled HARQ transmission of the packet over one TTI and send a bundled HARQ retransmission of the packet in response to a NACK.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method implemented in a wireless transmit/receive unit (WTRU) for performing a bundled transmission, the method comprising:
generating a packet for 2 ms transmission time interval (TTI) enhanced dedicated channel (E-DCH) transmission; and
sending a bundled transmission of the packet such that the packet is repeatedly transmitted over at least two consecutive TTIs, wherein the WTRU does not process a hybrid automatic repeat request (HARQ) feedback in an enhanced HARQ indicator channel (E-HICH) for the packet after sending the bundled transmission.

2. The method of claim 1 further comprising:
flushing a HARQ buffer at completion of the bundled transmission; and
generating a new packet for an E-DCH transmission for a next HARQ cycle on a condition that data is available.

3. The method of claim 1 wherein the WTRU does not process the HARQ feedback in an E-HICH on a condition that an indication via at least one of a high speed shared control channel (HS-SCCH) order, a reserved bit on an E-DCH absolute grant channel (E-AGCH), layer 2 signaling, and layer 3 signaling is received.

4. The method of claim 1 wherein the bundled transmission is configured per HARQ process.

5. The method of claim 4 wherein the WTRU transmits HARQ retransmission of another packet in one of the TTIs scheduled for the bundled transmission on a condition that a TTI scheduled for the HARQ retransmission of another packet overlaps one of the TTIs scheduled for the bundled transmission.

6. The method of claim 5 wherein a total number of autonomous transmissions of the packet in the bundled transmission is calculated as a number of TTIs of the bundled transmission minus a number of TTIs for the HARQ retransmission of another packet.

7. A method implemented in a wireless transmit/receive unit (WTRU) for performing a bundled transmission, the method comprising:
generating a packet for 2 ms transmission time interval (TTI) enhanced dedicated channel (E-DCH) transmission;
sending a hybrid automatic repeat request (HARQ) transmission of the packet, the HARQ transmission being a non-bundled transmission over one TTI;
receiving and processing HARQ feedback for the packet via an E-DCH HARQ indicator channel (E-HICH); and
sending a bundled HARQ transmission of the packet such that the packet is repeatedly transmitted over at least two TTIs on a condition that the HARQ feedback indicates a failure of delivery of the packet.

8. The method of claim 7 wherein the WTRU does not process an HARQ feedback in an E-HICH for the packet after sending the bundled transmission.

9. The method of claim 7 further comprising:
flushing an HARQ buffer at completion of the bundled transmission; and
generating a new packet for E-DCH transmission for a next HARQ cycle on a condition that data is available.

10. The method of claim 7 wherein the bundled transmission is configured per HARQ process.

11. The method of claim 10 wherein the WTRU transmits HARQ retransmission of another packet in one of the TTIs scheduled for the bundled transmission on a condition that a TTI scheduled for the HARQ retransmission of another packet overlaps one of the TTIs scheduled for the bundled transmission.

12. The method of claim 11 wherein a total number of autonomous transmissions of the packet in the bundled transmission is calculated as a number of TTIs of the bundled transmission minus a number of TTIs for the HARQ retransmission of another packet.

13. A wireless transmit/receive unit (WTRU) configured to perform a bundled transmission, the WTRU comprising:
a transmitter configured to transmit a packet for 2 ms transmission time interval (TTI) enhanced dedicated channel (E-DCH) transmission; and
a controller configured to control the transmitter to send a bundled transmission of the packet such that the packet is repeatedly transmitted over at least two TTIs, wherein the controller does not process a hybrid automatic repeat request (HARQ) feedback in an enhanced HARQ indicator channel (E-HICH) for the packet after sending the bundled transmission.

14. The WTRU of claim 13 wherein the controller is configured to flush a HARQ buffer at completion of the bundled transmission and generate a new packet for an E-DCH transmission for a next HARQ cycle on a condition that data is available.

15. The WTRU of claim 13 wherein the controller is configured to not process the HARQ feedback in an E-HICH on a condition that an indication via at least one of a high speed shared control channel (HS-SCCH) order, a reserved bit on an E-DCH absolute grant channel (E-AGCH), layer 2 signaling, and layer 3 signaling is received.

16. The WTRU of claim 13 wherein the bundled transmission is configured per HARQ process.

17. The WTRU of claim 16 wherein the controller is configured to transmit HARQ retransmission of another packet in one of the TTIs scheduled for the bundled transmission on a condition that a TTI scheduled for the HARQ retransmission of another packet overlaps one of the TTIs scheduled for the bundled transmission.

18. The WTRU of claim 17 wherein the controller is configured to calculate a total number of autonomous transmissions of the packet in the bundled transmission as a number of TTIs of the bundled transmission minus a number of TTIs for the HARQ retransmission of another packet.

19. A wireless transmit/receive unit (WTRU) configured to perform a bundled transmission, the WTRU comprising:
a transmitter configured to transmit a packet for 2 ms transmission time interval (TTI) enhanced dedicated channel (E-DCH) transmission; and
a controller configured to control the transmitter to send a hybrid automatic repeat request (HARQ) transmission of the packet via a non-bundled transmission over one TTI, process HARQ feedback for the packet via an E-DCH HARQ indicator channel (E-HICH) and send a bundled HARQ transmission of the packet such that the packet is repeatedly transmitted over at least two TTIs on a condition that the HARQ feedback indicates a failure of delivery of the packet.

20. The WTRU of claim 19 wherein the controller is configured to not process an HARQ feedback in an E-HICH for the packet after sending the bundled transmission.

21. The WTRU of claim 19 wherein the controller is configured to flush an HARQ buffer at completion of the bundled transmission, and generate a new packet for E-DCH transmission for a next HARQ cycle on a condition that data is available.

22. The WTRU of claim 19 wherein the bundled transmission is configured per HARQ process.

23. The WTRU of claim 22 wherein the controller is configured to transmit HARQ retransmission of another packet in one of the TTIs scheduled for the bundled transmission on a condition that a TTI scheduled for the HARQ retransmission of another packet overlaps one of the TTIs scheduled for the bundled transmission.

24. The WTRU of claim 22 wherein the controller is configured to calculate a total number of autonomous transmissions of the packet in the bundled transmission as a number of TTIs of the bundled transmission minus a number of TTIs for the HARQ retransmission of another packet.
